(19) United States
(12) Patent Application Publication
(10) Pub. No.: US 2008/0185226 A1
(43) Pub. Date: Aug. 7, 2008

(54) Lubricant Tank and Lubrication System

(76) Inventor: Werner Saam, Oberhausen-Rheinhausen (DE)

Correspondence Address: FISH & RICHARDSON, PC, P.O. BOX 1022, MINNEAPOLIS, MN, 55440-1022, US

(21) Appl. No.: 11/629,564

(22) PCT Filed: Jun. 10, 2005
(86) PCT No.: PCT/EP2005/006259

§ 371 Date: Nov. 29, 2007

(30) Foreign Application Priority Data
Jun. 14, 2004 (DE) 20 2004 009 387.1

(51) Int. Cl. F16N 1/00

(52) U.S. Cl. 184/4

(57) ABSTRACT

The invention relates to a lubricant tank (B), in particular, for a lubrication pump (P), with an outer envelope (1a, 1b, 1c), defining an inner cross-section, constant over the length (L1 to L3), a displaceable follower piston (T) arranged in a sealed manner within the envelope for variable definition of the lubricant storage volume (F) and a spring arrangement (A), supported in the lubricant tank (B), tensioning the follower piston (T) in the longitudinal direction of the envelope on the side away from the lubricant collector chamber and a lubrication system (S) with such a lubricant tank. According to the invention, such lubricant tanks and lubrication systems can have a high operational reliability with economical and simple construction, whereby the spring arrangement (A) comprises at least two spring units (E1, E2, E3), arranged in the longitudinal direction and acting in series.

The invention relates to a lubricant tank according to the preamble of claim 1 and a lubrication system according to the preamble of claim 11.

In lubrication systems with a lubrication pump it is known (DE 200 21 026 U) to equip the lubricant tank (for grease or oil) with a follower piston tensioned by gravity, so that the lubricant is securely guided into the inlet chamber of the lubrication pump. In lubrication pumps that do not always have a vertical working position of the lubricant tank, e.g. in the rotating hub of a wind power station, the gravitation cannot permanently tension the follower piston as desired. Therefore, it is known in practice to have the follower piston tensioned by a spring arrangement to ensure secure feeding of the follower piston and thus also the lubricant, e.g. also under the influence of centrifugal forces. Depending on the size of a machine to be lubricated, e.g. a wind power station, for ensuring the envisaged maintenance intervals with e.g. equally efficient lubricant locations, various sizes of lubricant tanks that are always made to measure are employed. The various tank sizes cause cost-intensive part variety. Such a lubricant tank contains at least one to two kilograms of lubricant, or, depending on the demand, even more. In case of larger lubricant tanks, the spring arrangement consists e.g. of a conical spring with a predetermined loaded length of spring, a predetermined spring rate and a predetermined spring characteristic. As the conical spring has to control the complete stroke itself, there is a problem in that with full lubricant storage volume and highly compressed conical spring, the effective force at the follower piston is undesirably high, and it becomes too weak for a secure function of the lubrication pump when the storage volume has become clearly smaller or shortly before the point of time for maintenance has come.

The object underlying the invention is to provide a lubricant tank and a lubrication system which ensure high operational reliability with economical and simple construction.

The object is achieved with the features of claim 1 and subclaim 11.

The disadvantage of an initially too high tensioning force and a too weak tensioning force towards the end is eliminated in a large lubricant tank with economical and simple construction by subdividing the spring arrangement into a row of individual spring units, i.e. if a size or length of the lubricant tank is required where an individual spring unit would necessarily result in the above-mentioned disadvantages. By the subdivision of the spring arrangement into individual spring units connected in series, a stepwise elongation of the travel of the spring system without simultaneous clear increase of the initial force exerted on the follower piston and also without too drastic a reduction of the final force is achieved. Here, the knowledge that a row of spring units permits a long travel of the spring system, and if the weakest spring unit is not compressed to block, it always acts with the force of the weakest spring unit is utilized. With a size of the lubricant tank with which the used stroke distance of the follower piston can be controlled by one single spring unit without any problems, however, only one spring unit has to be employed. In larger lubricant tanks, however, two or more spring units are connected one after the other to prolong the travel of the spring system to be used with favourable forces as desired in a modular manner. In this manner, the desired support of the lubrication pump is in each case ensured via the used stroke distance and the lubricant is securely fed. In this manner, the operational reliability is increased in a simple manner. This can be particularly practical in wind power stations where the lubricant tank rotates and where possibly even centrifugal forces act which could affect the feeding of the lubricant into the inlet chamber of the lubrication pump. The increased operational reliability by the subdivision of the spring arrangement, however, can also be practical for lubricant tanks or lubrication systems designed for other cases of application.

Conveniently, each spring unit is a conical spring. This conical spring can have a simple design, i.e. consist of one spring wire, or it can have a multiple design, i.e. be wound from several spring wires or formed from conical springs fitted into each other. For a conical spring has the advantage of a short loaded length of spring in a completely compressed state, so that with a given fitting length, a long spring stroke can be utilized until the tension of the spring is completely or largely released.

Alternatively, each spring unit can also be a coil spring in simple or multiple design. As a further alternative, it is conceivable to form each spring unit of a disk spring stack.

For the spring units connected in series to correctly cooperate, it is practical to arrange an intermediate plate between each of them which is smaller than the inner cross-section of the outer envelope of the lubricant tank. However, embodiments where the ends of abutting spring units match such that an intermediate plate is dispensable are also conceivable.

For a favourable power transmission it is practical, if conical springs are used, to support them each in pairs with their large-diameter or small-diameter ends at a common intermediate plate. The intermediate plate can also consist of two plates each of which is e.g. mounted to one spring end.

For the effective force to develop in a predetermined manner over the used stroke of the follower piston, it is practical to combine conical springs with identical designs in the spring arrangement.

If, however, a special course of the development of the spring force over the stroke is desired, the conical springs can also be designed with different loaded lengths of spring and/or different spring rates and/or different spring characteristics.

It would also be conceivable to provide different types of springs in the installed spring units.

To avoid the disadvantage of having a wide part variety for various sizes of lubricant tanks (various tank fixing flanges, follower plates, metal parts, tank lids and the like), according to a further, important aspect of the invention, the lubricant tank is modularly made from an outer envelope kit in various sizes each with a different length of the outer envelope but with the same inner cross-section. Thus, for various tank sizes, the same tank fixing flanges, follower pistons, intermediate plates, tank lids and the like can be used. This selection of the respective proper outer envelope from a kit with different lengths of outer envelopes is particularly profitably combined with the measure of subdividing the spring arrangement into individual spring units arranged in series as of a certain size of the lubricant tank or length of the outer envelope.

Depending on the application, the inner cross-section of the outer envelope can be round or four-cornered. The contour of the follower piston is adapted to each inner cross-section while the intermediate plates not necessarily have to be adapted to the inner cross-section.

In the lubrication system it is practical to select an outer envelope from a kit with different lengths of outer envelopes having the same inner cross-sections according to the storage volume required for a predetermined maintenance rate of the lubricant consumer, and, as of a predetermined lubricant tank size, to subdivide the spring arrangement into individual spring units and to have these spring units act in series.

With reference to the drawing, embodiments of the subject matter of the invention are illustrated. In the drawing:

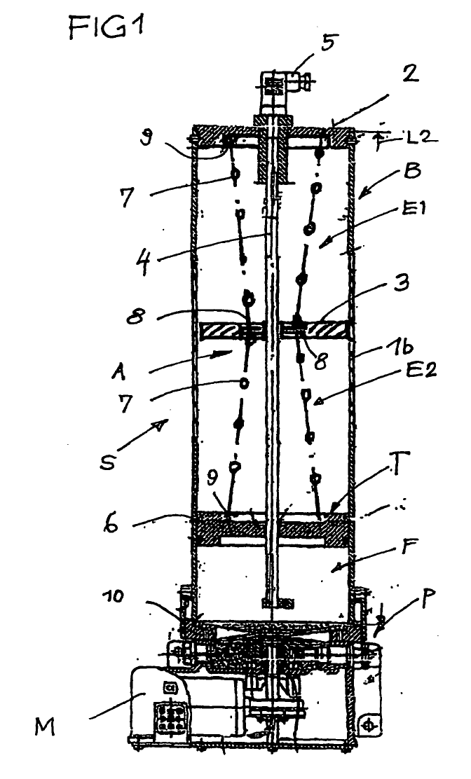

FIG. 1 shows a lubrication system with a lubricant tank of medium size,

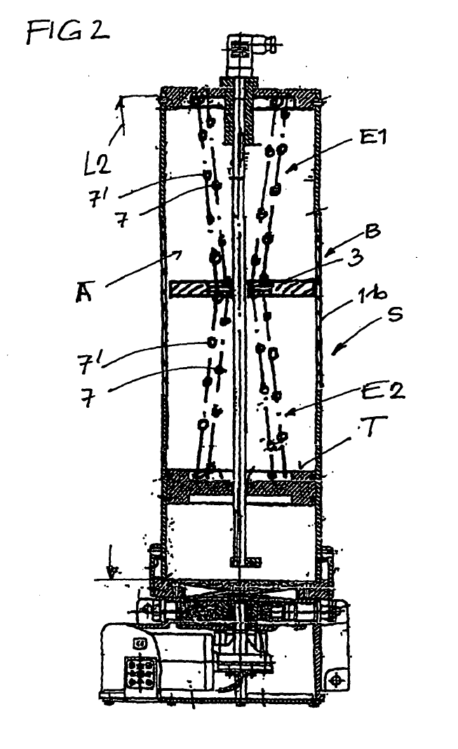

FIG. 2 shows a lubrication system with a lubricant tank of medium size in another embodiment,

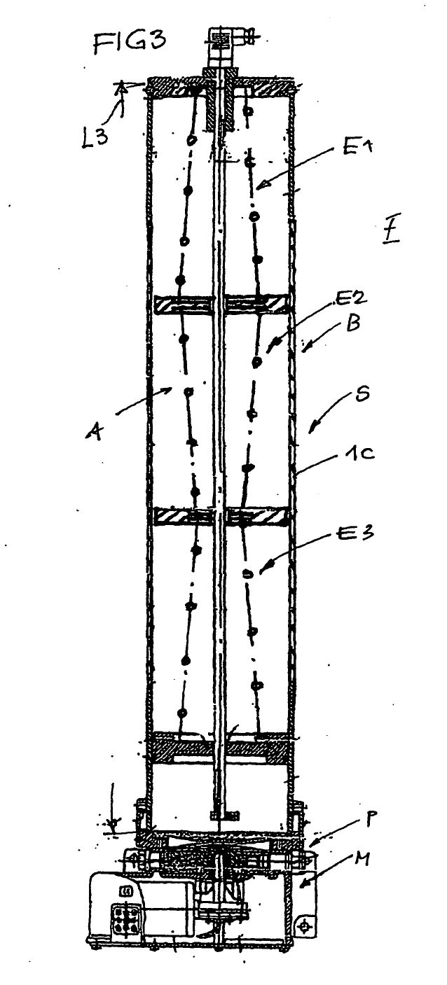

FIG. 3 shows a lubrication system with a lubricant tank of large size, and

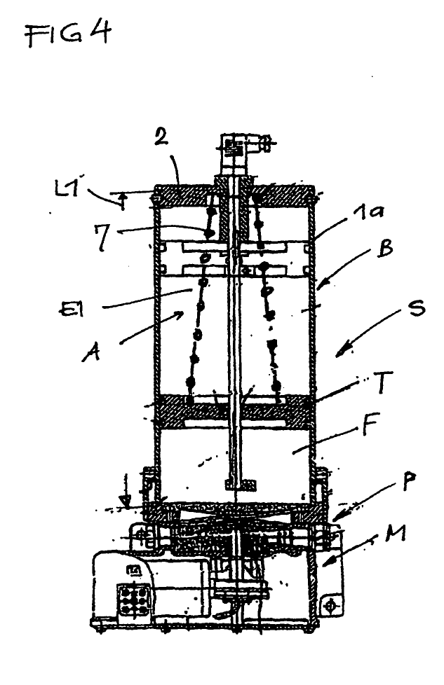

FIG. 4 shows a lubrication system with a lubricant tank of small size.

A lubrication system S, for example a central lubrication system that can be installed in the hub region of a wind power station, which is operated with a lubricant, such as oil or grease, comprises a lubrication pump P driven by a motor M and a lubricant tank B functionally connected with it. For example, the lubricant tank B is connected to the lubrication pump or a housing containing the lubrication pump or the motor via a tank fixing flange 10. The lubricant tank B has a for example round or four-cornered outer envelope 1b of a length L2 defining an inner cross-section constant over the length. The upper end of the outer envelope 1b is closed by a lid 2. In the outer envelope 1b, a follower piston T is guided in a sealed and displaceable manner (seals 6) and limits a lubricant collector chamber F and is tensioned by a spring arrangement A towards the lubrication pump P. The spring arrangement A is supported, for example, at the lid 2.

The outer envelope 1b can be a commercially available plastic or metal pipe or profile. For designing various sizes of lubricant tanks B, outer envelopes of various lengths are selected from a kit, while the tank fixing flange 10, the follower piston T and the lid 2 can each have the same design. The selected size of the lubricant tank depends on the lubrication demand of the machine or device to be lubricated, and possibly also on the maintenance rates which are predetermined. Normally, the sizes of the lubricant tanks of such lubrication systems start with contents of 1 to 2 kg, and there are no limits upwards.

In the lubricant tank, a level monitoring device is provided which consists of a switch tube 4 penetrating the follower piston T, with a switching component situated at the bottom and a plug connection 5 provided outside at the lubricant tank B. The switch tube 6 is necessary for various tank sizes in various lengths, while the plug connection 5 can always be the same. These measures, i.e. to use outer envelopes having various lengths but the same inner cross-section and only switch tubes of various lengths, reduces the part variety in the manufacture of lubricant tanks B having various sizes.

The spring arrangement A in the embodiment which is shown in FIG. 1 comprises at least two spring units E1 and E2 arranged in series and separated by at least one intermediate plate 3. The intermediate plate 3 e.g. has a smaller contour than the inner cross-section of the outer envelope 1b. In FIG. 1, the spring units E1, E2 are conical springs 7. Here, the two conical springs 7 are supported with their small-diameter ends 8 at the intermediate plate 3, while the large-diameter end 9 of the upper conical spring 7 is supported at the lid 2, and the large-diameter end 9 of the lower conical spring 7 is supported at the follower piston T.

The two conical springs 7 can be identical, i.e. have the same loaded length of spring, the same spring rate and the same spring characteristic. However, it is also conceivable to design the one conical spring different from the other conical spring 7 to achieve a different force characteristic.

Conical springs, such as the shown conical springs 7, have the advantage of a very short overall length in a compressed state and thus the advantage of a long usable spring stroke. Furthermore, for this purpose of application, they have favourable spring characteristics. It is desirable to have a spring characteristic where the difference between the spring force acting on the follower piston T with a compressed spring and with a more tension-released spring is as low as possible and changes as linearly as possible between these force values.

Alternatively, each spring unit E1, E2 could also be formed of a coil spring, or else of a disk spring stack or of an annular spring stack. It would be furthermore conceivable to employ spring units consisting of plastic material. A spring of the one type could also cooperate with a spring of another type in the same lubricant tank. An intermediate plate 3 is not absolutely necessary; however, it can be practical between the spring units for perfect power transmission.

In FIG. 1, the outer envelope 1b has a length L2 resulting in a certain volume of the lubricant storage volume F and which is so long that one single spring unit or one single conical spring would be problematic as the force exerted by the single conical spring onto the follower piston T in a compressed state of the conical spring would be too high (with, a full lubricant tank), however, in the tension-released or nearly tension-released state (empty lubricant tank), it would be too small for a secure function for feeding the lubricant to the lubrication pump P. Therefore, with a certain length, such as the length L2, and in response to the inner cross-section, a subdivision of the spring arrangement A into at least two spring units E1, E2 arranged one behind the other would be practical as thus a long usable travel of the spring system arises without the initial force being too high and the end force too low. In other words, the long travel of the spring system can be achieved without having to accept e.g. a too high initial force and/or too strong a difference between the initial force and the end force.

As required, in one spring unit E1, E2, two or several individual springs can also be combined. In this manner, all desired force relations and characteristics can be realised according to the function. In the embodiment in FIG. 2, for example, both spring units E1, E2 of the spring arrangement A in the lubricant tank B, the outer envelope 1b of which e.g. essentially has the same length L2 as the outer envelope in FIG. 1, are each formed of two conical springs 7, 7′ fitted into each other. The further construction of the lubrication system S in FIG. 2 largely corresponds to that of FIG. 1.

FIG. 3 illustrates an embodiment of a lubrication system S with an even larger lubricant tank B. In this embodiment, the outer envelope 1c has a length L3 which is longer than the length L2 in FIGS. 1 and 2. In order to nevertheless benefit from the advantage of a long usable travel of the spring system e.g. with an only moderate initial force and no drastic difference between the initial and end forces, the spring arrangement A in FIG. 3 is subdivided into three spring units E1, E2, E3 arranged one behind the other. Here, the spring units are conical springs 7, although, as mentioned, other spring types could also be used. The switch tube 4 for level monitoring always has to have a correspondingly long design. The other components, such as the lid 2 and the fixing flange 10 as well as the follower piston T and the two intermediate plates 3 provided here, can be adopted without amendment.

FIG. 4 illustrates an embodiment of a lubrication system S with such a small tank size that the spring arrangement A can consist of one single spring unit E1, for example a conical spring 7. The conical spring 7 (or another spring) is designed such that the initial force is not too high and the end force is still sufficient. The outer envelope 1a has a length L1 which is shorter than the length L2 in FIGS. 1 and 2 and also shorter than the length L3 in FIG. 3. The inner cross-section of the outer envelope 1a, however, is the same, so that the same components (except for the switch tube 4) as in the other embodiments can be used to design the lubricant tank B and installed into the lubrication system.

Basically, for achieving a long travel of the spring system via which the follower piston is tensioned with force, the invention consists in subdividing the spring arrangement into units and in connecting these units in series, if with only one spring unit an unfavourably high initial force would result, and possibly in selecting and designing the spring units such that they are alike, and even an individual one of such spring units can be used for a small tank size in an individual arrangement. This principle can be conveniently combined with various lengths of outer envelopes having the same inner cross-section to reduce the part variety in the manufacture of lubricant tanks of various sizes, so that finally, for example, one single type of the spring unit, the tank fixing flange, the follower piston, the intermediate plate, the lid and the level sensor can be used for all tank sizes, while the outer envelopes and the switch tubes have various lengths, but are conveniently also cut from continuous lengths.

Lubrication systems equipped with such lubricant tanks are not only practical for wind power stations where the lubricant and the follower piston are possibly even subjected to centrifugal forces counteracting the feeding of lubricant to the lubrication pump, but also for other employments where a secure feeding of the lubricant to the lubrication pump is important.

1. Lubricant tank, in particular for a lubrication pump, with an outer envelope defining an inner cross-section constant over the length, a displaceable follower piston arranged in a sealed manner within the outer envelope for variable definition of a lubricant storage volume, and a spring arrangement supported in the lubricant tank, tensioning the follower piston in the longitudinal direction of the outer envelope on a side away from the lubricant collector chamber, characterized in that the spring arrangement comprises at least two spring units arranged in the longitudinal direction and acting in series.

2. Lubricant tank according to claim 1, characterized in that a spring unit comprises a conical spring either in single or multiple design.

3. Lubricant tank according to claim 1, characterized in that a spring unit comprises a coil spring either in single or multiple design.

4. Lubricant tank according to claim 1, characterized in that a spring unit comprises a disk spring stack.

5. Lubricant tank according to claim 1, characterized in that the spring units are separated by an intermediate plate which is smaller than the inner cross-section of the outer envelope.

6. Lubricant tank according to claim 2, characterized in that in the series arrangement two conical springs each are supported with their large-diameter or their small-diameter ends at a common separation plated.

7. Lubricant tank according to claim 2, characterized in that in the series arrangement, the conical springs are designed with the same loaded length of spring, the same spring rate and the same spring characteristic.

8. Lubricant tank according to claim 2, characterized in that in the series arrangement, the conical springs are designed with different loaded lengths of spring and/or different spring rates and/or different spring characteristics.

9. Lubricant tank according to claim 1, characterized in that the outer envelope is selected from a kit with different lengths of outer envelopes of the same inner cross-section depending on the required storage volume, and that as of a certain outer envelope length at least two spring units arranged in series are provided.

10. Lubricant tank according to claim 1, characterized in that the inner cross-section is round or four-cornered.

11. Lubrication system for a variable working position relative to the gravitation direction, with a lubrication pump and a lubricant tank functionally connected to the lubrication pump, comprising an outer envelope with an inner cross-section constant over the length and a follower piston displaceable therein, characterized in that in the lubricant tank in the outer envelope the follower piston is tensioned by a spring arrangement, and that the spring arrangement comprises at least two spring units arranged in the longitudinal direction and acting in series.

12. Lubrication system according to claim 11, characterized in that the outer envelope is selected from a kit with different lengths of outer envelopes of the same inner cross-section depending on the storage volume required for a predetermined maintenance rate of a lubricant consumer, and that as of a certain outer envelope length at least two spring units arranged in series are provided.

13. A device comprising:
a lubricant tank comprising an outer envelope defining an inner cross-section that is constant over the length of the lubricant tank;
a displaceable follower piston arranged in a sealed manner within the outer envelope for variable definition of a lubricant storage volume; and
a spring arrangement supported in the lubricant tank, tensioning the follower piston in the longitudinal direction of the outer envelope on a side away from a lubricant collector chamber,
wherein the spring arrangement comprises at least two spring units arranged in the longitudinal direction and acting in series.

14. The device of claim 14, wherein a first of the at least two spring units comprises a coil spring in single or multiple design.

15. The device of claim 14, wherein a first of the at least two spring units comprises a disk spring stack.

16. The device of claim 14, wherein the spring units are separated by an intermediate plate which is smaller than the inner cross-section of the outer envelope.

17. The device of claim 14, wherein a first of the at least two spring units comprises a conical spring in single or multiple design.

18. The device of claim 17, wherein:
the spring units each comprise a conical spring; and
each of the two conical springs in the series arrangement is supported with its large-diameter or small-diameter end at a common separation plate.

19. The device of claim 17, wherein:
the spring units each comprise a conical spring; and
the conical springs in the series arrangement have the same loaded length of spring, the same spring rate, and the same spring characteristic.

20. The device of claim 17, wherein:
the spring units each comprise a conical spring; and
the conical springs have one or more of a different loaded length of spring, a different spring rate, and a different spring characteristic.

21. The device of claim 14, wherein the outer envelope comprises a selection from a kit of outer envelopes having different lengths of a same inner cross-section.

22. The device of claim 14, wherein the outer envelope defines a round or four-cornered inner cross-section.

23. The device of claim 14, further comprising a lubrication system for a variable working position relative to the direction if gravity, wherein the lubrication system comprises a lubrication pump and the lubricant tank functionally connected to the lubrication pump.

24. The device of claim 14, wherein the device is formed by selecting the outer envelope from a kit of outer envelopes having different lengths of a same inner cross-section based on a storage volume to achieve a predetermined maintenance rate of a lubricant consumer,
wherein as of a certain outer envelope length the at least two spring units arranged in series are provided for the outer envelopes of the kit.
